(19) United States
(12) Patent Application Publication
(10) Pub. No.: US 2026/0307461 A1
(43) Pub. Date: Oct. 8, 2026

(54) HEATING APPARATUS

(71) Applicant: AISAN KOGYO KABUSHIKI KAISHA, Obu-shi (JP)

(72) Inventors: Hiroyuki TAKAHASHI, Obu-shi (JP); Jun TAKASAKI, Obu-shi (JP)

(21) Appl. No.: 19/629,055

(22) Filed: Mar. 26, 2026

(30) Foreign Application Priority Data
Apr. 2, 2025 (JP) 2025-061406

(51) Int. Cl. B60H 1/22; F24H 9/18

(52) U.S. Cl. CPC B60H 1/2215; F24H 9/18; B60H 2001/2271; B60H 2001/2278; F24H 2250/02

(57) ABSTRACT

A heating apparatus may include a plurality of heaters each extending in a first direction, in which the heaters are arranged in a second direction perpendicular to the first direction; a housing section that houses the plurality of heaters; a supply passage that extends in the first direction above the housing section, in which a heat medium to be supplied to the housing section flows through the supply passage; and a supply opening that communicates the supply passage with the housing section and extends in the first direction. The supply passage may include a narrowed portion extending in a direction from an inlet of the supply passage toward a downstream side. A flow cross-sectional area of the narrowed portion may decrease in the direction from the inlet of the supply passage toward the downstream side.

### CROSS REFERENCE TO RELATED APPLICATION

This application claims priority to Japanese Patent Application No. 2025-061406 filed on April 2, 2025. The entire content of the priority application is incorporated herein by reference.

### TECHNICAL FIELD

The art disclosed herein relates to a heating apparatus.

### BACKGROUND ART

Japanese Patent Application Publication No. 2017-218117 describes a heating apparatus. The heating apparatus of Japanese Patent Application Publication No. 2017-218117 includes PTC heaters, a housing section that houses the PTC heaters, and a supply passage through which a heat medium to be supplied to the housing section flows.

In a heating apparatus configured to heat a heat medium using heaters, the heaters may extend in the same direction (a first direction) and be arranged in a direction perpendicular to that direction (a second direction). In this case, a heat medium may be supplied such that it flows along the arrangement direction of the heaters (i.e., the second direction). This may lead to uneven heating of the heat medium. For example, when the heat medium is supplied from a heat-medium supply passage to a housing section that houses the heaters, the supply of heat medium may not proceed smoothly in the vicinity of the inlet of the supply passage. Thus, the heaters may be overheated in the vicinity of the inlet of the supply passage, resulting in uneven heating of the heat medium. The disclosure herein provides a technology for evenly heating a heat medium.

### SUMMARY

A heating apparatus may comprise a plurality of heaters each extending in a first direction, wherein the heaters are arranged in a second direction perpendicular to the first direction; a housing section that houses the plurality of heaters; a supply passage that extends in the first direction above the housing section, wherein a heat medium to be supplied to the housing section flows through the supply passage; and a supply opening that communicates the supply passage with the housing section and extends in the first direction. The supply passage may comprise a narrowed portion extending in a direction from an inlet of the supply passage toward a downstream side. A flow cross-sectional area of the narrowed portion may decrease in the direction from the inlet of the supply passage toward the downstream side.

### BRIEF DESCRIPTION OF DRAWINGS

FIG. 1 is a top view of a heating apparatus according to an embodiment.

FIG. 2 is a side view of the heating apparatus according to the embodiment.

FIG. 3 is a cross-sectional view taken along line III-III in FIG. 1.

FIG. 4 is a top view of a heating apparatus according to a modification.

FIG. 5 is a side view of the heating apparatus according to the modification.

FIG. 6 is a top view of a heating apparatus according to another modification.

FIG. 7 is a side view of the heating apparatus according to the other modification.

### DETAILED DESCRIPTION

In one aspect of the present teachings, a heating apparatus may comprise a plurality of heaters each extending in a first direction, wherein the heaters are arranged in a second direction perpendicular to the first direction; a housing section that houses the plurality of heaters; a supply passage that extends in the first direction above the housing section, wherein a heat medium to be supplied to the housing section flows through the supply passage; and a supply opening that communicates the supply passage with the housing section and extends in the first direction. The supply passage may comprise a narrowed portion extending from an inlet of the supply passage toward a downstream side. A flow cross-sectional area of the narrowed portion may decrease in a direction from the inlet of the supply passage toward the downstream side.

With the above configuration, the pressure of the heat medium can be increased in the narrowed portion of the supply passage, thereby facilitating smooth supply of the heat medium from the supply passage to the housing section in the vicinity of the inlet of the supply passage. This suppresses overheating of the heaters in the vicinity of the inlet of the supply passage, allowing for uniform heating of the heat medium.

In one embodiment of the present teachings, the flow cross-sectional area of the narrowed portion may decrease as a dimension of the supply passage in the second direction decreases.

The above configuration allows the heat medium to flow smoothly along the second direction, allowing for smooth supply of the heat medium to the housing section.

In one embodiment of the present teachings, the flow cross-sectional area of the narrowed portion may decrease as a dimension of the supply passage in a third direction decreases, wherein the third direction may be perpendicular to both the first direction and the second direction.

The above configuration allows the heat medium to flow smoothly along the third direction, allowing for smooth supply of the heat medium to the housing section.

In one aspect of the present teachings, an electric vehicle may comprise any one of the above heating apparatuses.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved heating apparatuses.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

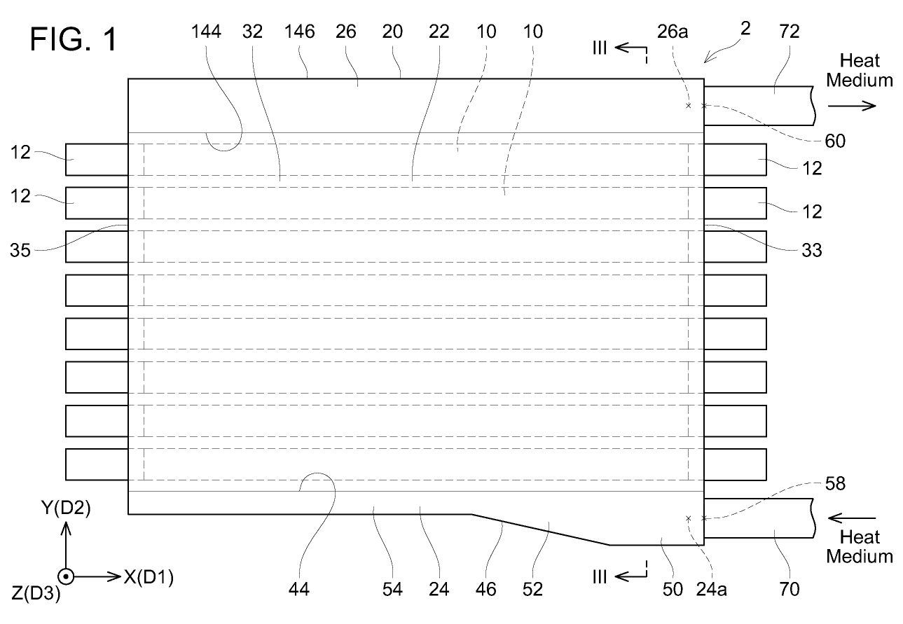

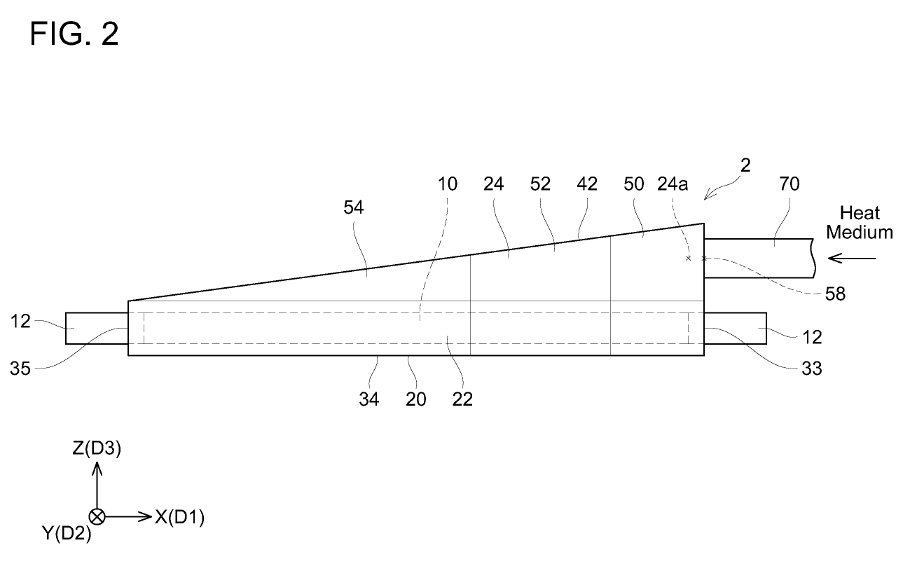

Referring to the drawings, a heating apparatus 2 according to an embodiment is described. As illustrated in FIGS. 1 to 3, the heating apparatus 2 according to the embodiment comprises a housing 20 and a plurality of heaters 10 housed in the housing 20. The heating apparatus 2 is configured to heat a liquid heat medium or a gas heat medium using the plurality of heaters 10. For example, the heating apparatus 2 is used to heat a heat medium (e.g., water or coolant) in a space-heating unit mounted in an electric vehicle. Hereinafter, the X direction in the drawings corresponds to a first direction D1, the Y direction corresponds to a second direction D2, and the Z direction corresponds to a third direction D3. The first direction D1, the second direction D2, and the third direction D3 are perpendicular to each other.

The housing 20 of the heating apparatus 2 comprises a body 22, a supply section 24 connected to the body 22, and a discharge section 26 connected to the body 22 on the opposite side to the supply section 24. The supply section 24 and the discharge section 26 are opposed to each other in the second direction D2.

The body 22 comprises a generally flat container and extends in the first direction D1 and the second direction D2. The body 22 comprises a housing section 28 that houses the plurality of heaters 10. The housing section 28 defines a heating passage 22a through which a heat medium to be heated by the plurality of heaters 10 flows.

The body 22 comprises an upper surface 32, a lower surface 34, a front surface 33, a rear surface 35, and a pair of side surfaces 36. The body 22 further comprises a supply opening 38 located near the supply section 24 and a discharge opening 40 located near the discharge section 26.

The upper surface 32 and the lower surface 34 of the body 22 each extend in the first direction D1 and the second direction D2. The plurality of heaters 10 is disposed between the upper surface 32 and the lower surface 34. The heating passage 22a is defined between the upper surface 32 and the lower surface 34.

The front surface 33 and the rear surface 35 of the body 22 each extend in the second direction D2 and the third direction D3. The side surfaces 36 of the body 22 each extend in the first direction D1 and the third direction D3. The plurality of heaters 10 is disposed between the pair of side surfaces 36.

The supply opening 38 and the discharge opening 40 of the body 22 are each formed in the upper surface 32 of the body 22 and open upward. The supply opening 38 and the discharge opening 40 are each elongated in the first direction D1. With respect to a heat medium flow direction, the supply opening 38 is located upstream of the plurality of heaters 10 and the discharge opening 40 is located downstream of the plurality of heaters 10.

The plurality of heaters 10 is housed in the housing section 28 of the body 22. The heaters 10 are arranged in a row adjacent to each other in the heating passage 22a of the body 22. The heaters 10 each extend in the first direction D1. The heaters 10 are spaced apart from each other in the second direction D2 perpendicular to the first direction D1. The heaters 10 are arranged along the heat medium flow direction. The heaters 10 heat the heat medium flowing through the heating passage 22a.

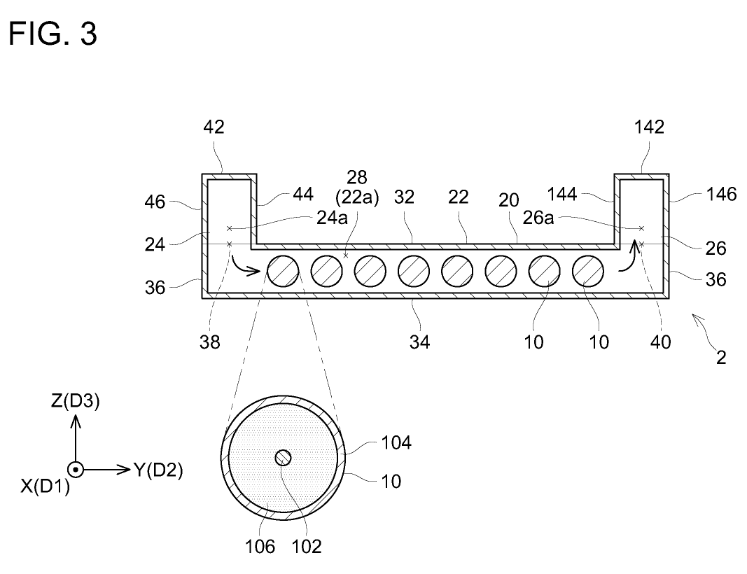

Each of the heaters 10 is, for example, a sheathed heater. As illustrated in the enlarged view of FIG. 3, each heater 10 comprises a heating element 102 made of a nichrome wire, a tube 104 that houses the heating element 102, and a powdery insulator 106 filling a space between the heating element 102 and the tube 104. Each heater 10 has a substantially cylindrical shape. Detailed description on the configuration of the sheathed heater is omitted since it is well known.

Each heater 10 comprises terminals 12, 12 at its opposing longitudinal end portions (i.e., end portions in the first direction D1). One longitudinal end portion of the heater 10 penetrates the front surface 33 of the body 22 of the housing 20 and is fixed to the front surface 33. The other longitudinal end portion of the heater 10 penetrates the rear surface 35 of the body 22 of the housing 20 and is fixed to the rear surface 35. The terminals 12, 12 of the heater 10 are located outside the housing 20 and electrically connected to an external power source. The heater 10 generates heat using electric power supplied from the external power source via the terminals 12, 12. The heater 10 generates heat by a current flowing through the heating element 102.

The heaters 10 may be electrically connected in parallel. Alternatively, the heaters 10 may be electrically connected in series. In the present embodiment, some of the heaters 10 (e.g., four heaters 10) are electrically connected in series, and groups of heaters 10, each including multiple heaters 10 (e.g., four heaters 10) connected in series, are electrically connected in parallel.

Now, the supply section 24 of the housing 20 is described. The supply section 24 of the housing 20 is fixed to the upper surface 32 of the body 22. The supply section 24 is connected to the supply opening 38 formed in the upper surface 32 of the body 22. The supply section 24 is located upstream of the body 22 in the heat medium flow direction. The supply section 24 defines a supply passage 24a through which the heat medium to be supplied to the housing section 28 (i.e., the heating passage 22a) of the body 22 flows. The heat medium is supplied from the supply section 24 through the supply opening 38 of the body 22 into the housing section 28 (i.e., the heating passage 22a) of the body 22. The supply opening 38 communicates the supply passage 24a with the housing section 28 (i.e., the heating passage 22a). The supply passage 24a is located above the housing section 28 (i.e., the heating passage 22a).

The supply section 24 extends in the first direction D1. The supply section 24 comprises an upper surface 42, an inner surface 44, and an outer surface 46. The upper surface 42 extends in the first direction D1 and the second direction D2. The inner surface 44 and the outer surface 46 each extend in the first direction D1 and the third direction D3. The inner surface 44 is located inward of the outer surface 46 in the second direction D2 (i.e., closer to the discharge section 26 than the outer surface 46 is). The outer surface 46 is located outward of the inner surface 44 in the second direction D2 (i.e., farther from the discharge section 26 than the inner surface 44 is). The supply passage 24a is defined between the inner surface 44 and the outer surface 46.

The supply section 24 comprises a first portion 50, a second portion 52, and a third portion 54. The first portion 50, the second portion 52, and the third portion 54 are arranged in the first direction D1. The first portion 50, the second portion 52, and the third portion 54 are arranged in this order from upstream to downstream in the heat medium flow direction.

The first portion 50 of the supply section 24 comprises an inlet 58 for the heat medium. The inlet 58 of the first portion 50 is open in the first direction D1. An inlet pipe 70 is connected to the inlet 58 of the first portion 50. The upstream end of the inlet pipe 70 is connected to a source of the heat medium and the downstream thereof is connected to the inlet 58 of the supply section 24. The heat medium is supplied from the inlet pipe 70 through the inlet 58 of the supply section 24 into the supply passage 24a of the supply section 24. The heat medium is supplied from the inlet pipe 70 into the first portion 50 of the supply section 24.

The upper surface 42 of the supply section 24 within the first portion 50 is inclined relative to the first direction D1. The upper surface 42 of the first portion 50 is inclined downward from upstream (i.e., the inlet 58 of the supply passage 24a) toward downstream in the heat medium flow direction. The upper surface 42 of the first portion 50 is inclined closer to the supply opening 38 of the heating passage 22a of the body 22 from upstream toward downstream in the heat medium flow direction. The flow cross-sectional area of the supply passage 24a within the first portion 50 decreases (narrows) from upstream toward downstream in the heat medium flow direction. The flow cross-sectional area of the supply passage 24a within the first portion 50 decreases as the dimension of the supply passage 24a in the third direction D3 decreases. The flow cross-sectional area of the supply passage 24a refers to the cross-sectional area of the supply passage 24a in its cross-section perpendicular to the first direction D1.

The upper surface 42 of the supply section 24 within the second portion 52 is inclined relative to the first direction D1. The upper surface 42 of the second portion 52 is inclined downward from upstream toward downstream in the heat medium flow direction. The upper surface 42 of the second portion 52 is inclined closer to the supply opening 38 of the heating passage 22a of the body 22 from upstream toward downstream in the heat medium flow direction.

The outer surface 46 of the second portion 52 is inclined relative to the first direction D1. The outer surface 46 of the second portion 52 is inclined closer to the inner surface 44 from upstream toward downstream in the heat medium flow direction. The flow cross-sectional area of the supply passage 24a within the second portion 52 decreases (narrows) from upstream toward downstream in the heat medium flow direction. The flow cross-sectional area of the supply passage 24a within the second portion 52 decreases as the dimension of the supply passage 24a in the second direction D2 and the dimension thereof in the third direction D3 decrease. The flow cross-sectional area of the supply passage 24a within the second portion 52 is smaller than the flow cross-sectional area of the supply passage 24a within the first portion 50.

The upper surface 42 of the supply passage 24a within the third portion 54 is inclined relative to the first direction D1. The upper surface 42 of the third portion 54 is inclined downward from upstream toward downstream in the heat medium flow direction. The upper surface 42 of the third portion 54 is inclined closer to the supply opening 38 of the heating passage 22a of the body 22 from upstream toward downstream in the heat medium flow direction. The flow cross-sectional area of the supply passage 24a within the third portion 54 decreases (narrows) from upstream toward downstream in the heat medium flow direction. The flow cross-sectional area of the supply passage 24a within the third portion 54 decreases as the dimension of the supply passage 24a in the third direction D3 decreases. The flow cross-sectional area of the supply passage 24a within the third portion 54 is smaller than the flow cross-sectional area of the supply passage 24a within the second portion 52.

Now, the discharge section 26 of the housing 20 is described. The discharge section 26 of the housing 20 is fixed to the upper surface 32 of the body 22. The discharge section 26 is connected to the discharge opening 40 formed in the upper surface 32 of the body 22. The discharge section 26 is located downstream of the body 22 in the heat medium flow direction. The discharge section 26 defines a discharge passage 26a through which the heat medium discharged from the housing section 28 (i.e., the heating passage 22a) of the body 22 flows. The heat medium is discharged from the heating passage 22a through the discharge opening 40 into the discharge passage 26a. The discharge opening 40 communicates the housing section 28 (i.e., the heating passage 22a) with the discharge passage 26a. The discharge passage 26a is located above the housing section 28 (i.e., the heating passage 22a). The heat medium discharged from the body 22 is discharged through the discharge section 26 to the outside.

The discharge section 26 extends in the first direction D1. The discharge section 26 comprises an upper surface 142, an inner surface 144, and an outer surface 146. The upper surface 142 extends in the first direction D1 and the second direction D2. The inner surface 144 and the outer surface 146 extend in the first direction D1 and the third direction D3. The inner surface 144 is located inward of the outer surface 146 in the second direction D2 (i.e., closer to the supply section 24 than the outer surface 146 is). The outer surface 146 is located outward of the inner surface 144 in the second direction D2 (i.e., farther from the supply section 24 than the inner surface 144 is). The discharge passage 26a is defined between the inner surface 144 and the outer surface 146.

The discharge section 26 comprises an outlet 60 for the heat medium. The outlet 60 of the discharge section 26 is open in the first direction D1. The outlet 60 of the discharge section 26 and the inlet 58 of the supply section 24 are open in the same direction (i.e., open rightward in FIG. 1). An outlet pipe 72 is connected to the outlet 60 of the discharge section 26. The upstream end of the outlet pipe 72 is connected to the outlet 60 of the discharge section 26 and the downstream end thereof is connected to a discharge location for the heat medium. The heat medium is discharged from the discharge passage 26a of the discharge section 26 through the outlet 60 of the discharge section 26 into the outlet pipe 72. The heat medium discharged from the discharge section 26 is discharged through the outlet pipe 72 to an external discharge location.

In the heating apparatus 2 described above, the heat medium is supplied from the inlet pipe 70 into the supply section 24 of the housing 20. The heat medium is supplied through the inlet 58 of the first portion 50 of the supply section 24 into the supply passage 24a. After supplied into the first portion 50 of the supply passage 24a, the heat medium flows downstream in the supply passage 24a and flows into the second portion 52 and the third portion 54 of the supply section 24.

Further, a part of the heat medium supplied into the first portion 50 flows from the first portion 50 of the supply passage 24a into the heating passage 22a of the body 22. A part of the heat medium that has flowed into the second portion 52 flows from the second portion 52 of the supply passage 24a into the heating passage 22a of the body 22. The heat medium that has flowed into the third portion 54 flows from the third portion 54 of the supply passage 24a into the heating passage 22a of the body 22. The heat medium flowing in the supply passage 24a flows into the heating passage 22a through the supply opening 38 of the body 22.

After flowing into the heating passage 22a of the body 22, the heat medium is heated by the plurality of heaters 10 disposed in the heating passage 22a while flowing downstream in the heating passage 22a. The heat medium heated by the plurality of heaters 10 flows downstream in the heating passage 22a and then flows into the discharge section 26. The heat medium flows from the heating passage 22a through the discharge opening 40 of the body 22 into the discharge passage 26a of the discharge section 26. After flowing into the discharge section 26, the heat medium is discharged into the outlet pipe 72 through the outlet 60 of the discharge section 26.

### Advantageous Effects

The heating apparatus 2 according to the embodiment has been described above. As is clear from the above description, the heating apparatus 2 comprises the heaters 10 that extend in the first direction D1 and are arranged in the second direction D2, and the housing section 28 that houses the heaters 10. The heating apparatus 2 further comprises the supply passage 24a that extends in the first direction D1 above the housing section 28, where the heat medium to be supplied into the housing section 28 flows, and the supply opening 38 that communicates the supply passage 24a with the housing section 28 and extends in the first direction D1. The supply section 24 comprises the first portion 50 extending downstream from the inlet 58. The flow cross-sectional area of the first portion 50 decreases from the inlet 58 of the supply passage 24a toward the downstream side.

With the above configuration, the pressure of the heat medium can be increased in the first portion 50 where the flow cross-sectional area gradually decreases, thereby facilitating smooth supply of the heat medium from the supply passage 24a into the housing section 28 in the vicinity of the inlet 58 of the supply passage 24a. This suppresses overheating of the heaters 10 in the vicinity of the inlet 58 of the supply passage 24a, allowing for uniform heating of the heat medium.

The flow cross-sectional area of the first portion 50 decreases as the dimension of the supply passage 24a in the third direction D3 decreases. This configuration facilitates causing the heat medium to flow downward, allowing for smooth supply of the heat medium into the housing section 28.

The supply section 24 further comprises the second portion 52, and the flow cross-sectional area of the second portion 52 decreases in the direction from the inlet 58 of the supply passage 24a toward the downstream side. The flow cross-sectional area of the second portion 52 decreases as the dimension of the supply passage 24a in the second direction D2 decreases. This configuration compresses the heat medium laterally, allowing for smooth supply of the heat medium into the housing section 28.

### Correspondence Relationships

The first portion 50 of the supply section 24 of the housing 20 is an example of “narrowed portion”. The second portion 52 of the supply section 24 of the housing 20 is another example of “narrowed portion”.

### Modifications

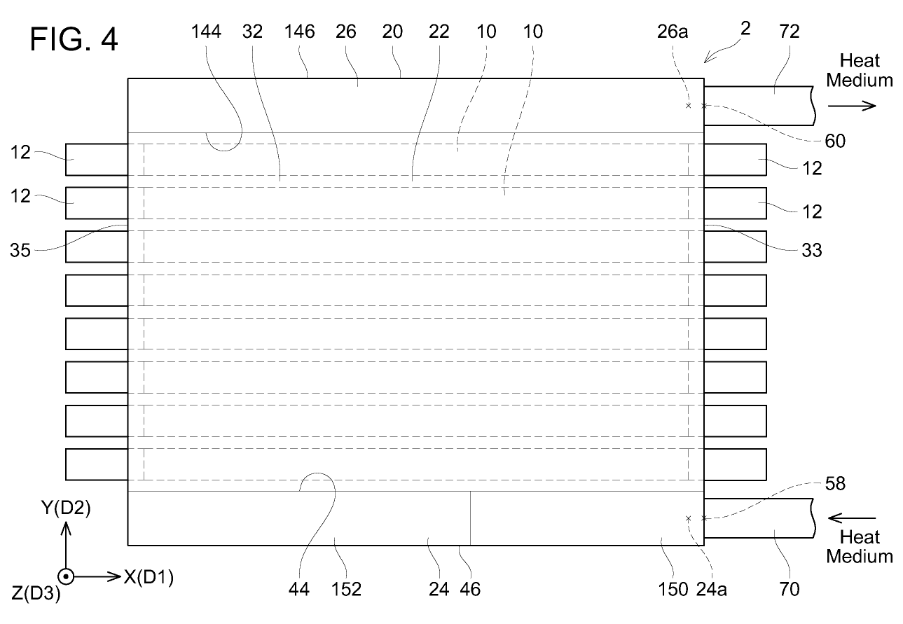

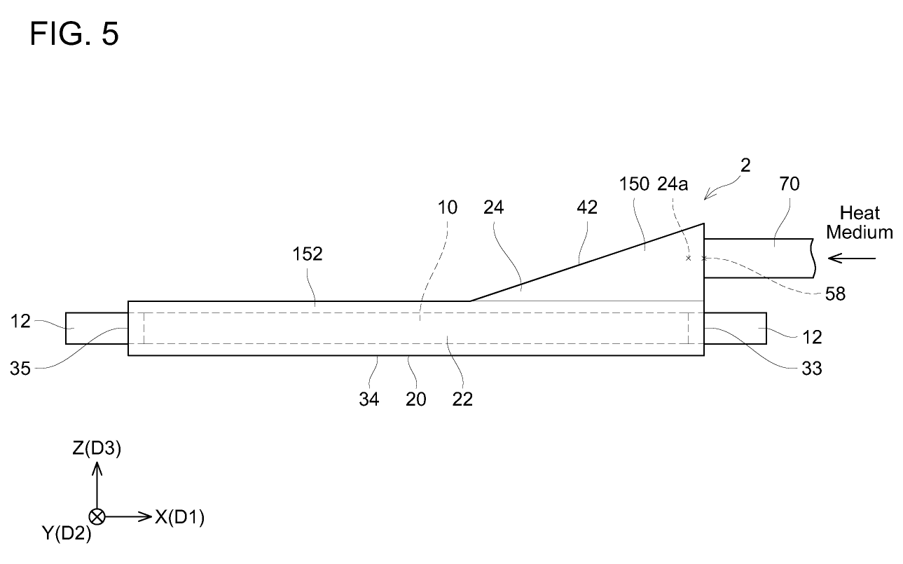

(1) The outer surface 46 of the supply section 24 of the housing 20 within the first portion 50 may be inclined relative to the first direction D1. The outer surface 46 within the first portion 50 may be inclined closer to the inner surface 44 from upstream toward downstream in the heat medium flow direction. The flow cross-sectional area of the supply passage 24a within the first portion 50 may decrease as the dimension of the supply passage 24a in the second direction D2 decreases.
(2) The outer surface 46 of the supply section 24 of the housing 20 within the third portion 54 may be inclined relative to the first direction D1. The outer surface 46 within the third portion 54 may be inclined closer to the inner surface 44 from upstream toward downstream in the heat medium flow direction. The flow cross-sectional area of the supply passage 24a within the third portion 54 may decrease as the dimension of the supply passage 24a in the second direction D2 decreases.
(3) The outer surface 46 of the supply section 24 of the housing 20 within the second portion 52 may not be inclined relative to the first direction D1.
(4) The length of the first portion 50 of the supply section 24 in the first direction D1 is not particularly limited. The length of the first portion 50 of the supply section 24 in the first direction D1 may, for example, be less than 1/2, less than 1/3, or less than 1/4 of the length of the supply section 24 in the first direction D1. (5) The length of the second portion 52 of the supply section 24 in the first direction D1 is not particularly limited. The length of the second portion 52 of the supply section 24 in the first direction D1 may, for example, be less than 1/2, less than 1/3, or less than 1/4 of the length of the supply section 24 in the first direction D1.
(6) The length of the third portion 54 of the supply section 24 in the first direction D1 is not particularly limited. The length of the third portion 54 of the supply section 24 in the first direction D1 may, for example, be less than 1/2, less than 1/3, or less than 1/4 of the length of the supply section 24 in the first direction D1.
(7) In the embodiment described above, the supply section 24 of the housing 20 comprises the first portion 50, the second portion 52, and the third portion 54, however, this need not always be the case. In a modification, as illustrated in FIGS. 4 and 5, the supply section 24 of the housing 20 may comprise a first portion 150 and a second portion 152 and may not comprise a third portion.

In the modification, the upper surface 42 of the supply section 24 within the first portion 150 is inclined relative to the first direction D1. The upper surface 42 within the first portion 150 is inclined downward from upstream (i.e., the inlet 58 of the supply passage 24a) toward downstream in the heat medium flow direction. The upper surface 42 within the first portion 150 is inclined closer to the supply opening 38 of the heating passage 22a of the body 22 from upstream toward downstream in the heat medium flow direction. The flow cross-sectional area of the supply passage 24a within the first portion 150 decreases (narrows) from upstream toward downstream in the heat medium flow direction. The flow cross-sectional area of the supply passage 24a within the first portion 150 decreases as the dimension of the supply passage 24a in the third direction D3 decreases. The first portion 150 of the supply section 24 is another example of “narrowed portion”. The flow cross-sectional area of the supply passage 24a within the second portion 152 may decrease (narrow) or may not decrease (narrow) from upstream toward downstream in the heat medium flow direction.

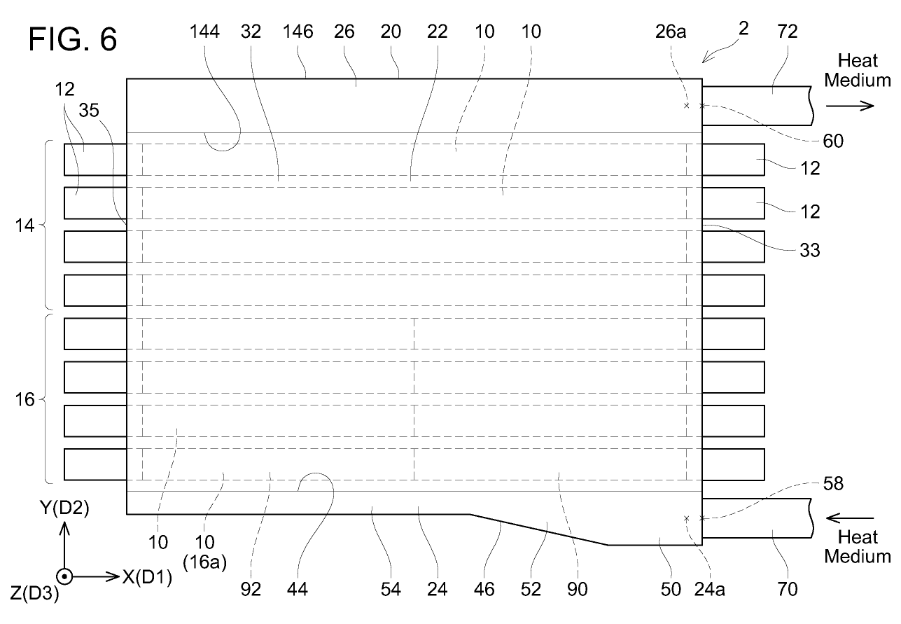

(8) As illustrated in FIG. 6, the plurality of heaters 10 may comprise a plurality of normal heaters 14 and a plurality of particular heaters 16. The plurality of normal heaters 14 is located downstream of the plurality of particular heaters 16 in the heat medium flow direction. The plurality of normal heaters 14 is located closer to the discharge passage 26a than the plurality of particular heaters 16 is. The plurality of particular heaters 16 is located upstream of the plurality of normal heaters 14 in the heat medium flow direction. The plurality of particular heaters 16 is located closer to the supply passage 24a than the plurality of normal heaters 14 is.

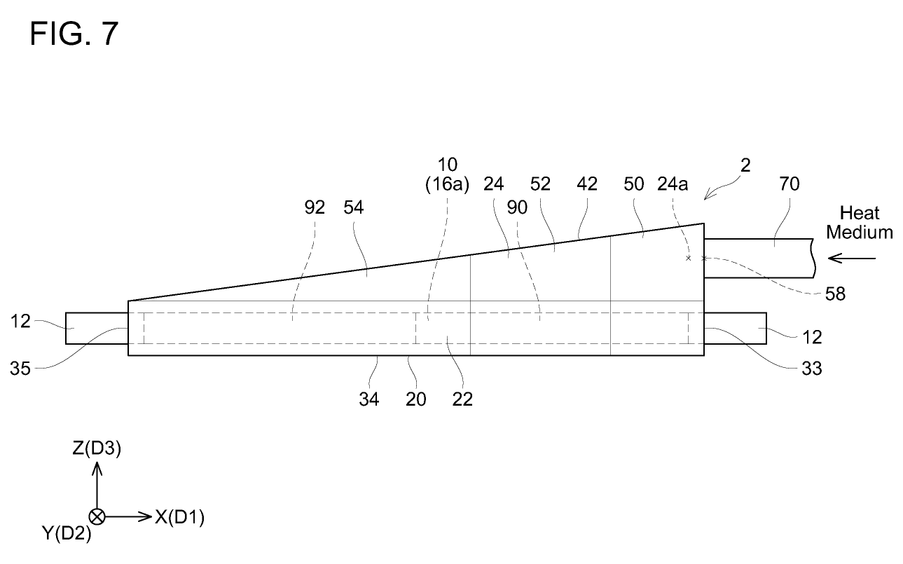

As illustrated in FIGS. 6 and 7, each particular heater 16 comprises a first portion 90 and a second portion 92. The first portion 90 and the second portion 92 are arranged in the first direction D1. The first portion 90 is located closer to the front surface 33 of the body 22 than the second portion 92 is. The first portion 90 is located closer to the inlet 58 of the supply passage 24a than the second portion 92 is. The second portion 92 is located closer to the rear surface 35 of the body 22 than the first portion 90 is. The second portion 92 is located farther from the inlet 58 of the supply passage 24a than the first portion 90 is.

An electrical resistance per unit length of the heating element 102 within the first portion 90 of the particular heater 16 is smaller than an electrical resistance per unit length of the heating element 102 within the second portion 92 of the particular heater 16. Thus, an amount of heat generated per unit length of the heating element 102 within the first portion 90 of the particular heater 16 is smaller than an amount of heat generated per unit length of the heating element 102 within the second portion 92 of the particular heater 16. In the modification, each particular heater 16 may not comprise the heating element 102 within the first portion 90. The first portions 90 of the particular heaters 16 may not generate heat.

The plurality of particular heaters 16 comprises a first particular heater 16a. The first particular heater 16a is the heater 10 located closest to the supply passage 24a among the plurality of heaters 10. The first particular heater 16a is the outermost heater 10 on the supply passage 24a side among the heaters 10 arranged in the second direction D2.

The normal heaters 14 have a different configuration from the particular heaters 16 and do not comprise first and second portions as the particular heaters 16 do. Each normal heater 14 has a uniform amount of heat generated per unit length across its length (i.e., the length in the first direction D1). The heating element 102 of each normal heater 14 has a uniform electrical resistance per unit length across its length (i.e., the length in the first direction D1) between the opposing ends.

In the modification above, the plurality of heaters 10 comprises the plurality of particular heaters 16, however, this need not always be the case. In a modification, there may not be multiple particular heaters 16. Thus, the plurality of heaters 10 may comprise only a single particular heater 16 (i.e., the first particular heater 16a).

What is claimed is:

1. A heating apparatus comprising:
a plurality of heaters each extending in a first direction, wherein the heaters are arranged in a second direction perpendicular to the first direction;
a housing section that houses the plurality of heaters;
a supply passage that extends in the first direction above the housing section, wherein a heat medium to be supplied to the housing section flows through the supply passage; and
a supply opening that communicates the supply passage with the housing section and extends in the first direction,
wherein
the supply passage comprises a narrowed portion extending in a direction from an inlet of the supply passage toward a downstream side, and
a flow cross-sectional area of the narrowed portion decreases in the direction from the inlet of the supply passage toward the downstream side.

2. The heating apparatus according to claim 1, wherein the flow cross-sectional area of the narrowed portion decreases as a dimension of the supply passage in the second direction decreases.

3. The heating apparatus according to claim 1, wherein the flow cross-sectional area of the narrowed portion decreases as a dimension of the supply passage in a third direction decreases, wherein the third direction is perpendicular to both the first direction and the second direction.

4. An electric vehicle comprising the heating apparatus according to claim 1.
